(19) United States
(12) Patent Application Publication
(10) Pub. No.: US 2011/0042842 A1
(43) Pub. Date: Feb. 24, 2011

(54) METHOD AND DEVICE FOR PRODUCING A COATED STRUCTURE

(75) Inventors: Josef Renkl, Markt Indersdorf (DE); Wolfgang Frehsdorf, Munchen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: KraussMaffaffei Technologies GmbH, Munchen (DE)

(21) Appl. No.: 12/990,258

(22) PCT Filed: Apr. 24, 2009
(86) PCT No.: PCT/EP09/54957

§ 371 Date: Oct. 29, 2010

(30) Foreign Application Priority Data
May 7, 2008 (DE) 10 2008 022 596.7

(51) Int. Cl. B29C 45/77; B29C 45/17; B29C 45/14; B29C 43/02

(52) U.S. Cl. 264/40.3; 425/149

(57) ABSTRACT

The present invention relates to a method and a device for producing a coated structure. A support structure is initially introduced into a mold, and subsequently a flooding gap is formed between the support structure and at least one part of the mold. Then, a negative pressure is generated in the flooding gap, and the flooding material is filled into the flooding gap. In order to avoid irregularities during the filling process, it is proposed to control or regulate the negative pressure in accordance with a predetermined pressure profile.

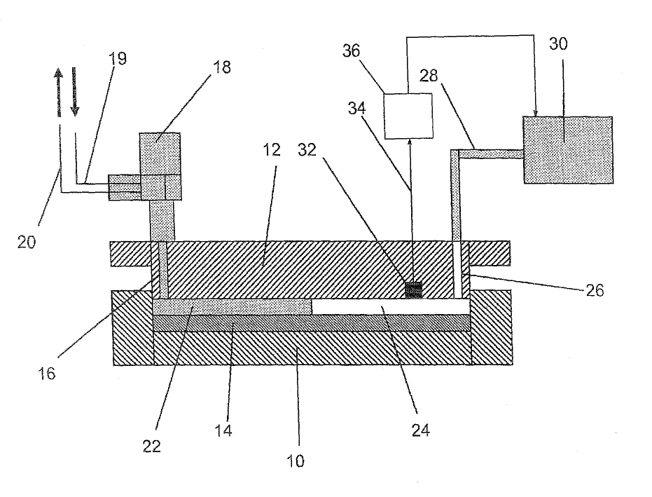

The present invention relates to a method and a device for producing a coated structure according to the preambles of claims 1 and 7.

It is known for some time to manufacture polyurethane skins in closed molding tools through flooding. In particular, it is known to coat support structures in closed molds through overflooding processes with a surface material. To support this flooding or coating process, it is moreover known to generate a negative pressure in the flooding gap between a support structure and a cavity wall. In this context, reference is made to documents U.S. Pat. No. 4,207,049, JP 03164218, DE 24 61 925, and U.S. Pat. No. 4,447,328.

There is a problem associated with the methods and devices described therein, relating to the change of the fill rate during introduction of the fill material within a significant range, causing adverse effects. It is possible for example to encounter a high flow rate, when the pressure is very small in the beginning and the fill material in particular on the flow front undergoes foaming, causing bubble formation. This bubble formation mars the quality of the coating layer and may even lead to consider the structure as waste. In particular when an unchangeable vacuum is predefined, for example as a result of an expansion process, the vacuum weakens during loading so that no negative pressure may no longer be present in the end stage of the loading process to support the filling process. In this case, the fill material must be introduced at a respective overpressure during the last process phase.

DE 22 34 723 describes a device for casting inset parts under reduced pressure which is generated by means of a vacuum pump. A sensor device is hereby provided for determining two pressure values, each adjustable. When reaching a first negative pressure value, the filling process for the molding tool is started. In case the pressure value falls below the second negative pressure value during the course of the filling operation, the vacuum pump is stopped. When the sensor signals the complete filling of the mold, the material supply is ended and the pressure level is brought to the ambient pressure in the mold. When the second negative pressure value is not reached in this system, the pressure level is not known. In particular in this situation, a predefined desired pressure profile is no longer controlling.

It is an object of the invention to provide a method and a device for producing a coated structure of a type involved here, in which the quality of the layer, in particular of the surface coating, as optimal as possible.

This object is attained by a method and device having the features set forth in claims 1 and 7, respectively.

Accordingly, an idea of the invention resides to control and regulate the negative pressure in correspondence with a specification. Thus, desired values are stored for the method sequence which is tracked as much as possible.

The control or regulation of the negative pressure impacts the fill rate of the system so that a desired fill rate profile can be established for the filling process when respectively adjusting the negative pressure. The vacuum may be varied depending on the specification in the range between 0 and 700 mbar.

Inference can be made to the negative pressure for example in the device for generating the negative pressure (negative pressure device, e.g. vacuum pump).

Furthermore, the negative pressure may also be ascertained in the flooding gap itself, for example by a pressure sensor. As an alternative or in addition, it is also possible to determine the fill rate of the flooding material in the flooding gap. The negative pressure can be fine-tuned on the basis of these two data.

For the purpose of regulation or control, a respective device (e.g. machine control) is provided which controls the negative pressure device (e.g. vacuum pump). Of course, the negative pressure may not only directly be controlled according to a predefined profile. The negative pressure may also be varied so that a predefined flooding rate profile is attained. In this case, the flooding rate profile is thus controlling. The negative pressure could then be controlled such that the flooding rate remains substantially unchanged during the entire filling process.

A vacuum pump may be provided for example as device for generating the negative pressure and is connected or can be connected via conduits and channels with the flooding gap in order to avoid additional openings in the molding tool, it is also possible, to produce the vacuum via the mixing head itself. For that purpose, the bore of the cleaning piston in the mixing head may be used. When the cleaning piston is retracted, a connection is established with the cavity of the molding tool, with the vacuum pump being connected or connectable with this bore in this case.

An embodiment of the present invention will now be described in greater detail with reference to the attached sole drawing.

The drawing shows hereby in a quite schematic manner a device according to the invention for carrying out the method according to the invention.

In particular, a molding tool with a molding tool bottom part 10 and a molding tool top part 12 is shown schematically, with the molding tool top part 12 being able to move up and down. As illustrated in the FIGURE, the molding tool top part 12 may dip into the recess of the molding tool bottom part 10 in a manner like a positive mold. A support structure 14 can be produced in a cavity of first size, for example by an injection molding process, as already known per se.

After the material has cured, for example the thermoplastic material for the support structure 14, the mold top part 12 is moved upwards—i.e. slightly opened—so that between the support structure 14 and the cavity wall of the mold top part 12 a flooding gap 24 is established which is still sealed off against the ambient environment.

A flooding material, for example a polyurethane material can be introduced by a mixing head 18 into this flooding gap 24. The mixing head 18 is hereby connected with the flooding gap 24 via a feed channel 16. The mixing head 18 receives its reactive components (e.g. isocyanate and polyol) via a component supply 19 and may also be operated in the so-called recirculation mode via a return line 20. This technology is generally known in the prior art so that a more detailed description is not necessary.

Illustrated in the FIGURE is a vent channel 26 to which a vent line 28 is connected and routed to a vacuum device 30. This vacuum device is acted upon in a controlled manner by a control or regulation device which is not shown in greater detail. As a result, the operation of the vacuum device (for example a vacuum pressure pump) can be adjusted in a desired manner through respective control. The vacuum device 30 is able to produce a defined vacuum in the flooding gap via the vent line 28 and the vent channel 26.

In the present illustration, half of the flooding gap is already filled with flooding material 22. The second half of the flooding gap 24 is still free and under a negative pressure. This negative pressure causes flooding material 22 to be drawn further into the flooding gap 24 in a defined manner and to be evenly dispersed. This can be assisted by a supply of the flooding material 22 at a defined pressure by means of the mixing head 18. The fill rate, in particular the course of the flow front, now depends significantly on the applied negative pressure.

The negative pressure is adjusted such that it is substantially the same in each fill state of the flooding gap 24. As a result the flow front spreads out at a predefined flow rate in the absence of any negative air inclusions in the area of the flow front.

As an alternative, the negative pressure may also be lowered or raised during filling. Also combinations thereof are possible. Moreover, it is also possible to suit the pressure control to the geometry of the flooding gap. Shown here is an even flooding gap. There are however also applications in which the thickness of the flooding gap may locally vary. In such a configuration, the negative pressure may also be adjusted in dependence on the position of the flow front in the tool, i.e. for example the negative pressure is lowered when thicker flooding zones are realized, or vice versa.

Overall, the fill rate can be suited via the regulation of the vacuum in the present invention so that no irregularities are encountered during the filling process and the coating surface can be realized with high quality.

### LIST OF REFERENCE SIGNS

10 mold bottom part
12 mold top part
14 support structure
16 feed channel
18 mixing head
19 component feed
20 component return
22 feed material
24 negative pressure
26 vent channel
28 vent line
30 negative pressure pump
32 pressure sensor
34 signal line

What is claimed is:

1.-11. (canceled)

12. A method, comprising the steps of:
forming a flooding gap between a support structure and a cavity wall in a closed molding tool;
generating a negative pressure in the flooding gap;
filling a flooding material into the flooding gap;
continuously controlling the negative pressure in the flooding gap in accordance with a predefined desired value specification to establish a flooding rate profile; and
executing the filling process by tracking the flooding rate profile.

13. The method of claim 12, further comprising the step of placing a support structure into the molding tool before the forming step, with the flooding gap being defined between the support structure and the molding tool.

14. The method of claim 12, further comprising the steps of executing an operation in at least one of two ways, a first way in which the negative pressure in the flooding gap is continuously determined, a second way in which a fill rate of the flooding material in the flooding gap is continuously determined.

15. The method of claim 12, further comprising the step of executing a compression molding step in the molding tool in combination with the controlling step.

16. The method of claim 12, wherein the controlling step is executed to keep the flooding rate substantially constant during the filling process.

17. A device, comprising:
a molding tool with a bottom part and a top part, said bottom and top parts defining a cavity there between;
a filling device for filling a filling material in a flooding gap of the molding tool,
a sensor assembly continuously ascertaining a negative pressure in the flooding gap or a flooding rate; to output a corresponding signal;
a control unit storing predefined desired values commensurate with establishing a desired pressure profile in the flooding gap and comparing the output signal received from the sensor assembly with the desired values; and
a negative pressure device fluidly connected with the flooding gap and responsive to the control unit for generating a variable negative pressure in accordance with the desired pressure profile and to attain a predefined flooding rate profile.

18. The device of claim 17, wherein the molding tool has a cavity for producing a support structure, said molding tool being constructed to establish the flooding gap between the support structure and a wall of the cavity.

19. The device of claim 17, wherein the filling device is a mixing head for a polyurethane system.

20. The device of claim 17, wherein the negative pressure device is constructed to ascertain the negative pressure.

21. The device of claim 17, wherein the sensor assembly includes a sensor provided in an area of the flooding gap.
